(19) United States
(12) Patent Application Publication
(10) Pub. No.: US 2013/0307413 A1
(43) Pub. Date: Nov. 21, 2013

(54) Circular Hollow Anode Ion Electron Plasma Source

(71) Applicant: Mark Edward Morehouse, Costa Mesa, CA (US)

(72) Inventor: Mark Edward Morehouse, Costa Mesa, CA (US)

(21) Appl. No.: 13/473,600

(22) Filed: May 17, 2012

(51) Int. Cl. H05H 1/46

(52) U.S. Cl. 315/111.31

(57) ABSTRACT

The Circular Hollow Anode Ion Electron Plasma Source is a hollow anode ion electron plasma source presenting the limited area of the inner surface only of an anode exit aperture, leading to high brightness and high efficiency in a simple robust plasma device.

### FIELD OF THE INVENTION

The present invention is a plasma source. More specifically it is an ion-electron source of the Hollow Anode type.

### BACKGROUND OF THE INVENTION

The present invention attempts to provide a unique hollow anode ion electron source type of plasma source that is capable of delivering plasma, ions and/or electrons, in a geometric shape other than that of a point source or of a linear slit. Specifically the present source is capable of providing charged particles in the form of a cylindrical sheath, an inwardly directed curtain or a diverging or converging cone of charged particles at any angle between axial and radial relative to the axis of symmetry of the device. Additionally, the source can have any convoluted shape desired, having any symmetry or lack thereof. Such devices might find extensive application as pre-ionization sources for Hall effect ion thrusters, as well as other types of accelerators that require plasma streams other than as a point source. A large market has developed over the last few decades for the need of plasma sources for material processing and charged particle beam applications.

### BRIEF DESCRIPTION OF THE INVENTION

The present invention is directed generally towards an ion electron source of the hollow anode type. More specifically towards a Hollow Anode plasma source that is capable of producing an annular ring of plasma ions or electrons for injection into a solenoidal magnetic field. Such geometrical designs find useful application in the production of ion and electron beam sources. Specifically they may be utilized as pre ionization sources for the production of beam injection into solenoidal magnetic fields as found in Morehouse U.S. Pat. No 7,825,601 and Morehouse U.S. Pat. No 8,138,677, incorporated herein by reference.

### BRIEF DESCRIPTION OF THE DRAWINGS

FIG. 1 represents the Prior Art in the field of Hollow Anode Ion Electron Source technology, being a point source.

FIG. 2 represents the Prior Art in the field of Hollow Anode Ion Electron Source technology, being a linear slit source.

FIG. 3 reveals a side cross sectional view of an axial annular ion electron plasma source. The working neutral gas 10 is introduced into the vacuum discharge structure 20. Cathode 30 and Anode 40 are energized by electrical means capable of providing voltages and currents proper to the breakdown of the gas into plasma. The exit Anode 40 is comprised of an inner surface only conductive aperture, which means that the only conductive aspect of the anode is in the exit slit 40 itself, all other anode surfaces are insulated from electrical conductivity to the plasma within the discharge chamber 20.

FIG. 4 reveals a side cross sectional view of a circumferential radial ion electron plasma source. The working neutral gas 10 is introduced into the vacuum discharge structure 20. Cathode 30 and Anode 40 are energized by electrical means capable of providing voltages and currents proper to the breakdown of the gas into plasma. The exit Anode 40 is comprised of an inner surface only conductive aperture, which means that the only conductive aspect of the anode is in the exit slit 40 itself, all other anode surfaces are insulated from electrical conductivity to the plasma within the discharge chamber 20.

FIG. 5 reveals a side cross sectional view of a conically converging ion electron plasma source. The working neutral gas 10 is introduced into the vacuum discharge structure 20. Cathode 30 and Anode 40 are energized by electrical means capable of providing voltages and currents proper to the breakdown of the gas into plasma. The exit Anode 40 is comprised of an inner surface only conductive aperture, which means that the only conductive aspect of the anode is in the exit slit 40 itself, all other anode surfaces are insulated from electrical conductivity to the plasma within the discharge chamber 20.

### DETAILED DESCRIPTION OF THE INVENTION

Miljevic, in U.S. Pat. No. 4,871,918, incorporated herein by reference, reveals a Hollow Anode Ion Electron source. It operates on the principle of an anode with a constricted gas exit from a discharge plasma generator. The patent reveals two outlet geometries. One is simply a single hole point source. This is the most basic design geometry. Another shape is revealed and claimed, that is a linear slit outlet. No other geometric design is claimed or revealed. The designs claimed by Miljevic fail to reveal and specify an annular or circumferential slit.

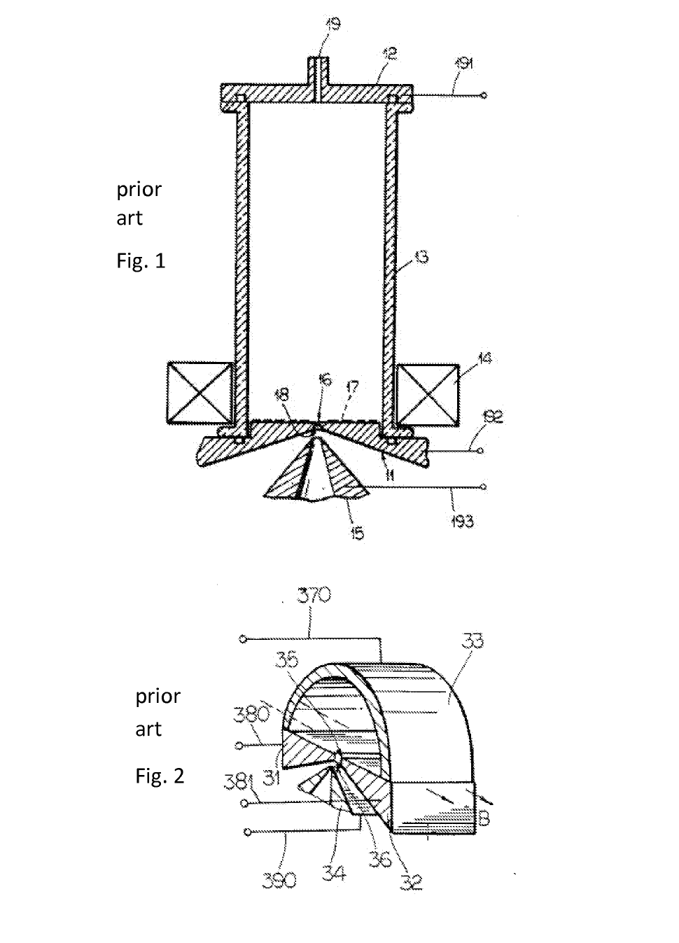

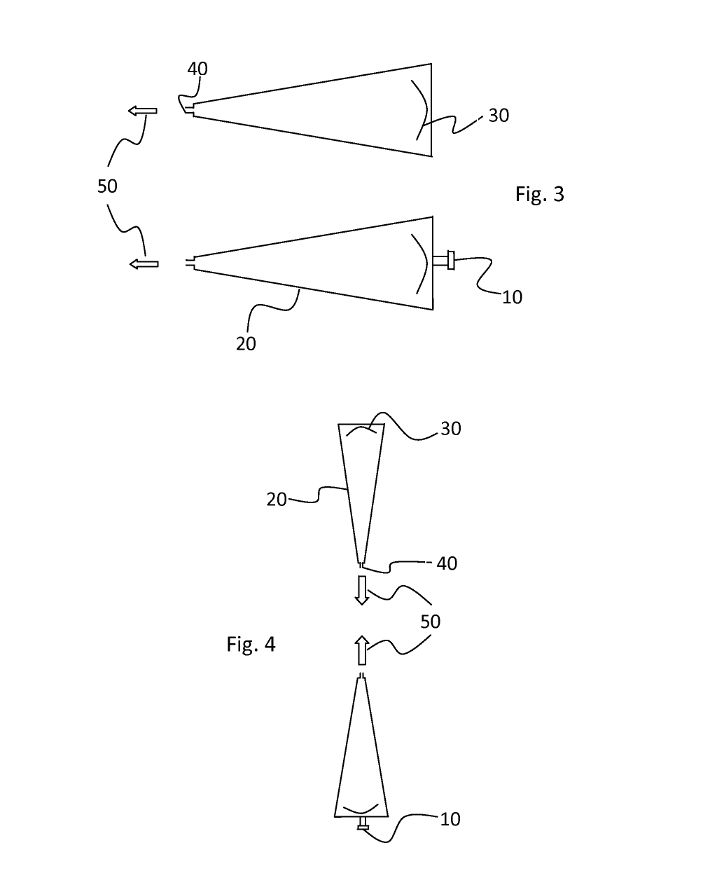

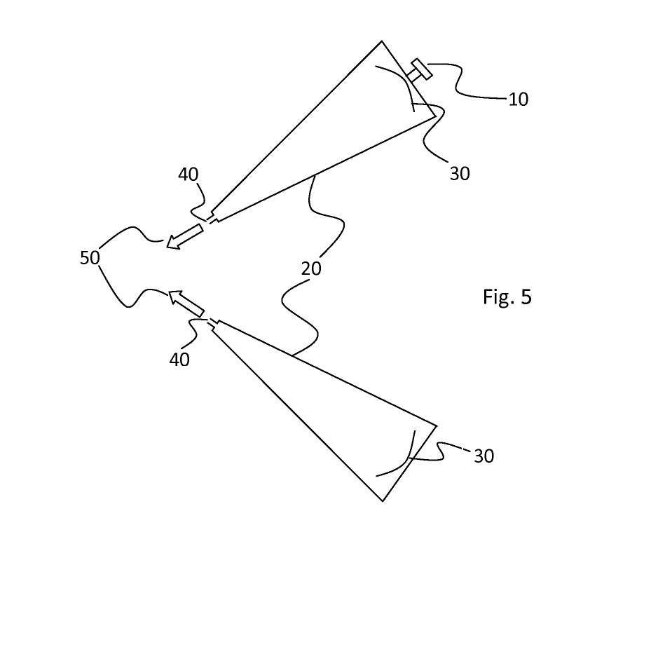

FIG. 1 shows a point source hollow anode plasma source of the Prior Art. Hollow anode electrode 11, cathode 12, housing 13, permanent of electromagnet 14, extraction electrode 15 and gas source inlet 19. Elements 191, 192 and 193 are the cathode, anode and extraction electrode leads, respectively. The lower side of the hollow anode 11 is the exit aperture of the source 18 and together with the extraction electrode 15 represents the modified Pierce geometry. The upper side of the anode 11 is insulated by a thin ceramic layer.

FIG. 2 reveals a linear slit design of the Prior Art hollow anode plasma source. A hemispherical cathode 22 with the hollow anode aperture 26 in the center of curvature is shown. Gas source inlet 23, hollow anode electrode 21, magnet 24, thin ceramic layer 27 and Pierce extraction system 25-28 are the same as in the previous drawing.

The present invention operates on the same hollow anode discharge principle but introduces a number of novel geometric configurations, providing new and useful streaming charged particle configurations. One preferred embodiment entails a geometrical design that is annular as apposed to a point source or linear slit, as provided by the prior art. In a preferred embodiment the annular exit anode is aligned axially, such that charged particles exit the source in a cylindrical sheath encircling. Another preferred embodiment introduces a circumferential design that directs the exiting charged particle source through the constricted anode in a radially inward direction, producing a generally radial curtain of charged particles perpendicular to the axis of the overall device. As these designs are mutually perpendicular, another preferred embodiment is provided capable of producing any angular configuration in between the two extremes. The charged particle stream generated by intermediate angles between axial and radial would generally produce a converging or a diverging cone of plasma. In each case the principle of operation is simple and follows closely that of Miljevic. Gas in introduced 10 generally in the vicinity of the cathode 30 or at the end of the device associated with the cathode 30. The gas travels from the cathode 30 through the body of the ionization chamber 20 towards the exit anode 40. The exit anode 40 has a restricted exit throat. The plasma 40 exit is comprised of an inner surface only conductive hollow anode exit aperture, which means that the only conductive aspect of the anode is in the exit slit itself, all other anode surfaces are insulated from electrical conductivity. This design requirement places a close tolerance requirement on the exit throat as the operation is dependent upon the anode exit being a constriction, which is comprised of an inner only conductive surface where electrons which are sourced at the cathode 30, become concentrated forming a high density of ionizing electrons at the area of the anode exit 40, producing a stream of charged particles 50. Another unique feature of the present invention applicable to all of the possible embodiments is that the ionization channel may be of any appropriate extended length to achieve the objective of the invention. The desirability of having a long ionization channel is that in order to produce a low density gas discharge, the ionization path needs to be long, to keep the discharge voltage at a minimum. The restriction on ionization is that set forth by Paschen and known widely as the Paschen curve, which equates the breakdown voltage to the gas pressure and the length of the discharge path. A further novel element to the present invention is that the channel walls 20, typically made of insulators, can be comprised of a conducting material or of insulators. By this means the range of possible Paschen breakdown parameters (specifically; path length as well as electric field strength) can be anything from the shortest distance between the anode and cathode across the insulator between the two and the farthest cathode 30 end of the ionization channel and the exit anode 40.

The present embodiments provide charged particle sources of greater flexibility and applicability than those that presently exist. The hollow anode design is superior to other sources such as hollow cathodes because of the concentration of electrons at the exit from the device. It is electrons that primarily serve to ionize the neutral gas in a plasma source and the constriction provided by the hollow anode source optimizes the ionization capability of the electrons.

1. A hollow anode ion electron plasma source comprising:
an annular vacuum discharge housing structure having one or more gas inlet opening(s);
a pair of electrodes, energized by a suitable source of electric power;
one of the pair of electrodes being an annular cathode contained within the discharge volume and generally associated with the gas source;
the second of the pair of electrodes being an anode spaced apart from the cathode electrode, said anode comprising an annular exit aperture having an inner surface wherein only inner surface is conductive, said aperture functioning as an exit aperture of the source;
a connecting means for connecting the anode and cathode to electrical power supplies, capable of providing an electrical discharge within the annular vacuum discharge housing;
gas entering the gas inlet, and producing a plasma therein;
said plasma exiting the hollow anode exit aperture.

2. A hollow anode ion electron plasma source comprising:
a circumferential vacuum discharge housing structure having one or more gas inlet opening(s);
a pair of electrodes, energized by a suitable source of electric power;
one of the pair of electrodes being a circumferential cathode contained within the discharge volume and generally associated with the gas source;
the second of the pair of electrodes being an anode spaced apart from the cathode electrode, said anode comprising a circumferential exit aperture having an inner surface wherein only inner surface is conductive, said aperture functioning as an exit aperture of the source;
a connecting means for connecting the anode and cathode to electrical power supplies, capable of providing an electrical discharge within the annular vacuum discharge housing;
gas entering the gas inlet, and producing a plasma therein;
said plasma exiting the hollow anode exit aperture.

3. A hollow anode ion electron plasma source comprising:
a conical vacuum discharge housing structure having one or more gas inlet opening(s);
a pair of electrodes, energized by a suitable source of electric power;
one of the pair of electrodes being a circular cathode contained within the discharge volume and generally associated with the gas source;
the second of the pair of electrodes being a circular anode spaced apart from the cathode electrode, said anode comprising a circular exit aperture having an inner surface wherein only inner surface is conductive, said aperture functioning as an exit aperture of the source;
a connecting means for connecting the anode and cathode to electrical power supplies, capable of providing an electrical discharge within the annular vacuum discharge housing;
gas entering the gas inlet, and producing a plasma therein;
said plasma exiting the hollow anode exit aperture.

4. The source of claim 1 further comprising:
an extended discharge housing comprised of insulating material of sufficient length to provide for electrical breakdown of gas at a pressure that accommodates any desired input pressure and gas flow rate.

5. The source of claim 2 further comprising:
an extended discharge housing comprised of insulating material of sufficient length to provide for electrical breakdown of gas at a pressure that accommodates any desired input pressure and gas flow rate.

6. The source of claim 3 further comprising:
an extended discharge housing comprised of insulating material of sufficient length to provide for electrical breakdown of gas at a pressure that accommodates any desired input pressure and gas flow rate.

7. The source of claim 4 further comprising:
an extended ionization channel composed of electrically conductive material.

8. The source of claim 5 further comprising:
an extended ionization channel composed of electrically conductive material.

9. The source of claim 6 further comprising:
an extended ionization channel composed of electrically conductive material.

10. The source of claim 3, further comprising:
an extended ionization channel composed of multiple electrodes interspaced with insulators along the length of the discharge channel.

11. The source of claim 4, further comprising:
an extended ionization channel composed of multiple electrodes interspaced with insulators along the length of the discharge channel.

13. The source of claim 1, containing an extraction electrode and connecting means for connecting the device of claim 1 and extraction electrode to electrical power supplies for production of a single species of accelerated charged particles.

15. The source of claim 2, containing an extraction electrode and connecting means for connecting the device of claim 2 and extraction electrode to electrical power supplies for production of a single species of accelerated charged particles.

16. The device of claim 1 with a radial magnetic field applied in the discharge vacuum space.

17. The source of claim 2 with an axial magnetic field applied in the discharge vacuum space.

18. The source of claim 1 with a radial magnetic field applied in the anode gap exit aperture.

19. The source of claim 2 with an axial magnetic field applied in the anode gap exit aperture.
